(19) United States
(12) Patent Application Publication
(10) Pub. No.: US 2002/0138772 A1
(43) Pub. Date: Sep. 26, 2002

(54) Battery management system employing software controls upon power failure to estimate battery duration based on battery/equipment profiles and real-time battery usage

(76) Inventors: Timothy James Crawford, Tucson, AZ (US); Jack Harvey Derenburger, Tucson, AZ (US)

Correspondence Address: Dan Hubert & Associates, 3111 Camino Del Rio North, 4th floor, San Diego, CA, 92108, US

(21) Appl. No.: 09/814,596

(22) Filed: Mar. 22, 2001

(51) Int. Cl. G06F 1/26; G06F 1/28; G06F 1/30

(52) U.S. Cl. 713/300

(57) ABSTRACT

A power management system uses software to predictively estimate remaining battery endurance by considering battery usage in context of a predetermined battery output and equipment load profiles, and appropriately issuing a shutdown alert or commencing a shutdown event as the end of battery endurance nears. More particularly, a battery supplies power to electrical equipment when a primary power source fails. Initially, the system receives one or more estimates of the battery's endurance and capability of supplying electrical power to the equipment. The system tracks battery use by prescribed electrical equipment. Utilizing software, for example, the system determines when estimated endurance minus battery usage equals a predetermined difference. Relative to this time, the system takes appropriate action(s) such as initiating shutdown of the equipment or issuing a shutdown alert.

### BACKGROUND OF THE INVENTION

1. Field of the Invention

The present invention relates to battery-driven backup power systems. More particularly, the invention concerns a system utilizing software controls to predictively estimate remaining battery endurance by considering battery usage in context of a predetermined battery output and equipment draw profiles, and thereafter issuing a shutdown alert or commencing a shutdown event at a prescribed time relative to the end of battery endurance.

2. Description of the Related Art

With mankind's increasing reliance on computers and other electronic devices, there has been a similarly increasing need for reliable electrical power. During most times, normal electrical power from the utility company provides adequate power. And, relatively minor power irregularities can be prevented with common devices such as surge protectors. Still, there remains an infrequent but pernicious threat of reduced utility voltage caused especially by high demand (“brownout”), or complete utility power interruption resulting from high demand or malfunction of power generating facilities (“blackout”). Complete power loss is undesirable for various reasons, including possible damage to electronic components and interruption of data availability.

For these reasons, battery backup systems are becoming increasingly popular. Basically, a battery backup system guarantees a continuous source of electrical power by supplying battery power in the event that utility power fails. Before battery power is exhausted, certain models of battery backup system initiate a graceful shutdown of the attached electronic components. Although this concept is simple in theory, there is considerable challenge in predicting the length of time that battery power will last before running out, referred to herein as “endurance.” If designers overestimate battery endurance, the battery backup system will run out of power before the protected electronics reach shutdown, exposing the electronics to possible damage. If designers underestimate battery endurance, the battery backup system will shut down prematurely, missing any possible utility power restoration that might be imminent, and thereby unnecessarily inconveniencing people using the protected equipment at that time.

Consequently, significant design effort has been expended to develop different approaches for estimating battery endurance. One simple approach is the “lowball” approach, where designers estimate battery endurance based upon the battery's electrical storage and the draw of the electronic equipment, and always initiate shutdown at an abundantly safe fixed time after power failure, well before the end of battery endurance under all possible scenarios. As mentioned above, this approach can shut down too early, missing an imminent utility power restoration that might be just around the corner.

In contrast to the lowball approach, others have taken the approach of developing a “smart” battery system that estimates battery endurance with precision using scientific measurement. Some of these smart battery systems sample the voltage or discharge of a battery while a device is on battery power, and use a microprocessor or various other electronic monitoring systems to analyze the real-time voltage output to determine when complete battery discharge is imminent. Some smart battery systems perform a system shutdown, destage data, or take other power saving steps when the measurements show the battery to be at some arbitrarily low charge state. Although these conventional “smart” battery systems offer some benefit because in accuracy of predicting battery endurance, there are also some drawbacks. For instance, known “smart” battery systems require the addition of electronic control devices to the battery system, such as voltage detectors, battery charge monitors, dedicated microprocessors, dedicated RAM, and the like. These additional components increase the battery system's design, development, and implementation costs, as well as the ultimate cost of the product to the customer. Furthermore, such hardware specific designs are not easily transported from one platform and battery system to another without major redesign, and therefore lack useful portability.

Consequently, known battery backup systems are not completely adequate for certain applications due to some unsolved problems.

### SUMMARY OF THE INVENTION

Broadly, the present invention concerns a system using software to predictively estimate remaining battery endurance by considering battery usage in context of predetermined battery output and equipment draw profiles, and appropriately issuing a shutdown alert or commencing a shutdown event as the end of battery endurance nears.

The invention is applied in a system where a battery supplies power to electrical equipment when a primary power source fails. Initially, the system receives one or more estimates of the battery's endurance to supply electrical power to the equipment. The system tracks battery use by prescribed electrical equipment. Utilizing software, the system determines when estimated endurance minus battery use equal a predetermined difference. Relative to this time, the system takes appropriate action such as initiating shutdown of the equipment or issuing a shutdown alert.

The foregoing features may be implemented in a number of different forms. For example, the invention may be implemented to provide a power management method. In another embodiment, the invention may be implemented to provide an apparatus such as a power management system with components such as a battery, power manager, various sensors, etc. In still another embodiment, the invention may be implemented to provide a signal-bearing medium tangibly embodying a program of machine-readable instructions executable by a digital data processing apparatus to perform power management operations as discussed herein. A different implementation concerns logic circuitry with multiple interconnected electrically conductive elements configured to perform the power management operations discussed herein.

The present invention affords its users with a number of significant advantages. For instance, the battery management system of the present invention is easy to implement and cost efficient to use because it uses software to track battery use and initiate shutdown when estimated battery endurance minus use reaches a predetermined level. Even if there are multiple power outages between full charges, the invention tracks the remaining battery endurance. Thus, the invention provides customers with longer battery availability during single or multiple power loss events.

The invention's hardware overhead is minimal, and surpasses prior approaches in ease and speed of deployment, reduced design, development, and implementation costs, and improved portability in conveniently extending to multiple platforms and battery systems. The invention avoids the need to implement specialized hardware such as voltage sensors, battery monitors, dedicated microprocessors, and the like. Additionally, the battery management technique of this invention allows the use of smaller batteries because it operates more efficiently, thereby avoiding the need to purchase larger, more expensive batteries.

The invention takes advantage of the fact that battery capacities and discharge rates for a given load can be predicted in test, based on simulated battery voltage curves measured in a test environment. Consequently, the present invention does not need to measure battery capacities, discharge rates, and output levels on the powered device during runtime, and further avoids the need for dedicated hardware components to make such measurements. Rather, this information is determined in advance from testing and specifications, and incorporated into a software-based battery manager that may even be integrated into an existing battery management system. With the battery information preprogrammed, the invention may be implemented as an add-on solution to an existing subsystem that manages the battery life and provides maximum on-battery endurance during power loss events free from any interference or addition.

One of the benefits of this new method is realized when battery technologies or power supply characteristics change. Instead of designing a new power management network with modified range and sensitivity of the voltage detectors and/or reprogrammed microprocessors (as with previous approaches), the present invention utilizes models of the battery's behavior in test and then incorporates these results into the invention's software-based battery management system.

The invention also provides a number of other advantages and benefits, which should be apparent from the following description of the invention.

### BRIEF DESCRIPTION OF THE DRAWINGS

FIG. 1 is a block diagram of the hardware components and interconnections of a power management system according to the invention.

FIG. 2 is a block diagram of a digital data processing machine according to the invention.

FIG. 3 shows an exemplary signal-bearing medium according to the invention.

FIG. 4 is a flowchart of a power management sequence according to the invention.

### DETAILED DESCRIPTION

The nature, objectives, and advantages of the invention will become more apparent to those skilled in the art after considering the following detailed description in connection with the accompanying drawings.

### Hardware Components & Interconnections

Introduction

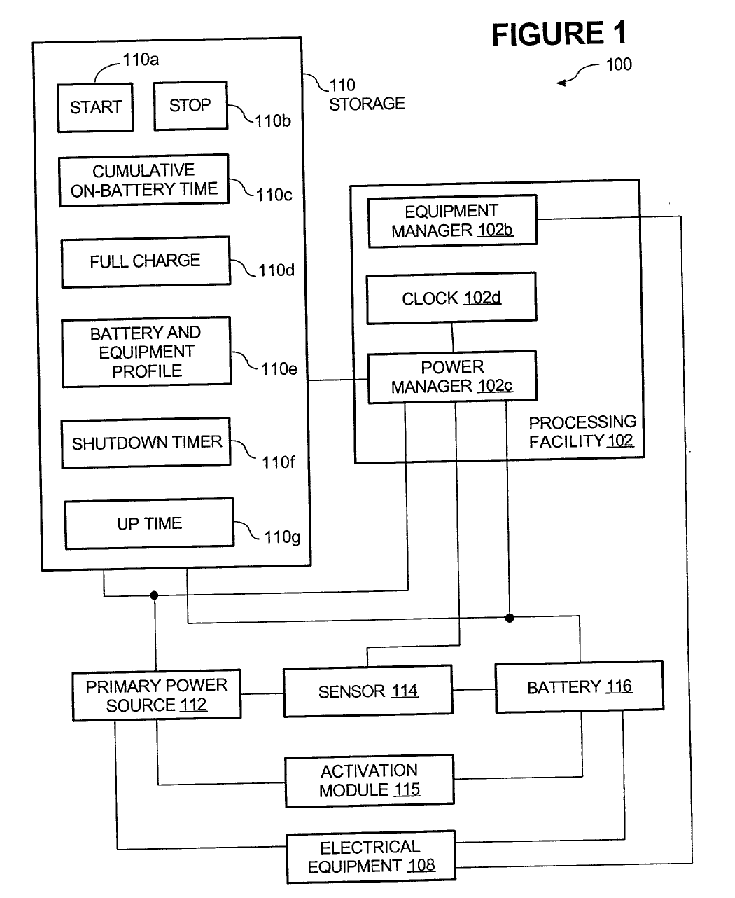

One aspect of the invention concerns a power management system, which may be embodied by various hardware components and interconnections, with one example being described by the power management system 100 of FIG. 1. As mentioned below, the system tracks battery use by certain electrical equipment and when estimated endurance minus actual battery use equal a predetermined number, the system takes appropriate action such as issuing a shutdown alert and/or initiating a shutdown sequence.

Electrical Equipment

The system 100 includes various electrical equipment 108, which normally receive power from a primary power source 112 and alternatively receive power from a battery 116 when the primary power source 112 is inadequate. The electrical equipment 108 is operated by an equipment manager 102b. Alternatively, the equipment manager 102b may be incorporated into the equipment 108. In one example, the equipment 108 comprises a mass storage facility with the manager 102b comprising a storage controller. Despite the specific example of mass storage, the invention also contemplates any conceivable form of electrical power consuming equipment such as computers, scientific measuring equipment, lighting, industrial equipment, manufacturing machines, telecommunications equipment, appliances, etc.

Primary Power Source

Normally, the components of the system 100 receive power from a primary power source 112. The primary power source 112 may have a remote origin such as a utility company, or local origin such as a generator powered by combustible fuel. As one example, the power source 112 may supply alternating current (A.C.) power.

Battery

The system 100 also includes a battery 116, which provides electrical power capable of substituting for that of the primary power source 112. Depending upon the needs of the application, the battery 116 may comprise a single battery or a bank of multiple batteries. The battery 116 is coupled to an activation module 115, also coupled to the power source 112, and serving to automatically invoke battery power when the primary power source 112 provides insufficient power. Operation of the activation module 115 may be satisfied by conventional machinery, such as a conventional uninterruptible power supply (UPS). The activation module 115 may employ line interactive, online, standby or other UPS technology. As one example, the battery may provide an output voltage slightly less than the primary power source 112 so that power from the source 112 is normally provided to the equipment 108 without drawing on the battery 116.

Sensor(s)

Another component of the system 100 is the sensor 114, which may be implemented by one sensor or multiple sensors depending upon the application. At minimum, the sensor 114 includes a device to sense whether the electrical equipment 108 is drawing off the battery 116 or the power source 112. Due to the software controls of the invention (described below), the power management system 100 may be implemented without requiring any sensor beyond this. Nonetheless, if desired, the sensor 114 may incorporate additional sensors such as a battery voltage sensor to sense whether the battery has reached “full charge.”

To suit the purpose of determining whether the equipment 108 is drawing off the battery 116 or power source 112, the sensor 114 may comprise a voltage sensor electrically coupled to the primary power source 112, thereby indicating when the power source 112 is providing a prescribed output voltage. In another example, the sensor 114 may comprise an ammeter coupled to the battery 116 to sense charge/discharge conditions. In still another example, the sensor 114 may be implemented by a line cord detection system such as a Rack Power Control (RPC) component of an IBM brand Enterprise Storage System (ESS) product. In another example, the functionality of the sensor 114 may be fulfilled by a power-loss or battery-activation sensor of the activation module 115, with this sensor therefore serving dual purposes; for instance, the RPC component may satisfy roles of both sensor 114 and activation module 115.

Processing Facility

Another component of the system 100 is the processing facility 102. The processing facility 102 includes a power manager 102c, equipment manager 102b, and clock 102d. As mentioned above, the equipment manager 102b manages the electrical equipment 108. The power manager 102c tracks battery use and commences an alert or shutdown of the equipment 108 at the appropriate time. For the sake of efficiency, the managers 102b/102c are both implemented by software executed by the processing facility 102, and may comprise separate software modules executed by the same hardware device. However, the equipment manager 102b may be omitted from the processing facility 102 and, for example, incorporated into the electrical equipment 108. Moreover, the equipment 108 and equipment manager 102b as shown may be eliminated, with the sole electrical components to be managed constituting the processing facility 102 itself.

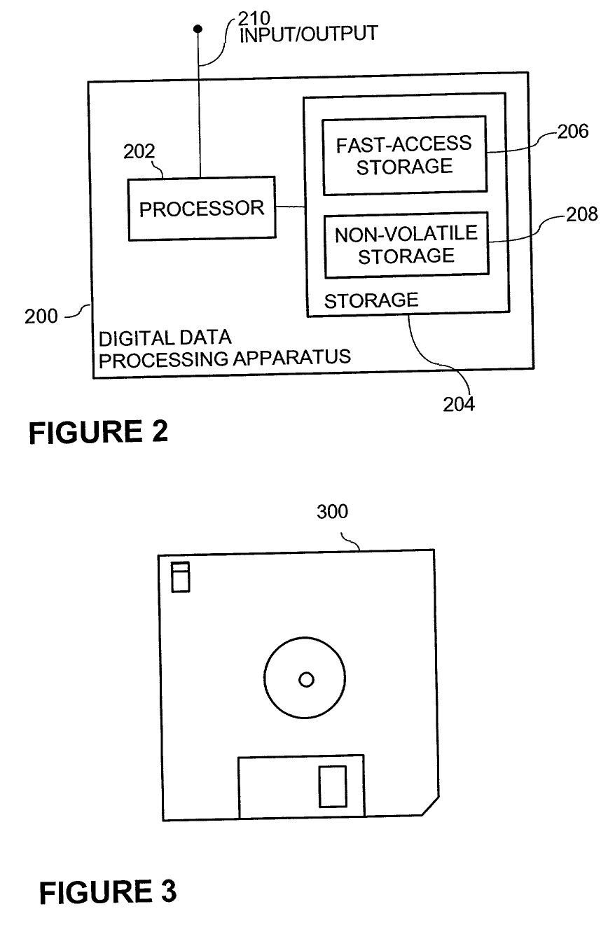

The processing facility 102 may be implemented in various forms. As one example, the facility 102 may comprise one or multiple digital data processing apparatuses, each as exemplified by the hardware components and interconnections of the digital data processing apparatus 200 of FIG. 2. In an even more particular example, the facility 102 may comprise dual RS-6000 type processors.

As shown in FIG. 2, the apparatus 200 includes a processor 202, such as a microprocessor or other processing machine, coupled to a storage 204. In the present example, the storage 204 includes a fast-access storage 206, as well as nonvolatile storage 208. The fast-access storage 206 may comprise random access memory (“RAM”), and may be used to store the programming instructions executed by the processor 202. The nonvolatile storage 208 may comprise, for example, one or more magnetic data storage disks such as a “hard drive”, a tape drive, or any other suitable storage device. The apparatus 200 also includes an input/output 210, such as a line, bus, cable, electromagnetic link, or other means for the processor 202 to exchange data with other hardware external to the apparatus 200.

Despite the specific foregoing description, ordinarily skilled artisans (having the benefit of this disclosure) will recognize that the apparatus discussed above may be implemented in a machine of different construction, without departing from the scope of the invention. As a specific example, one of the components 206, 208 may be eliminated; furthermore, the storage 204 may be provided on-board the processor 202, or even provided externally to the apparatus 200.

Logic Circuitry

In contrast to the digital data processing apparatus discussed above, a different embodiment of the invention uses logic circuitry instead of computer-executed instructions to implement the processing facility 102. Depending upon the particular requirements of the application in the areas of speed, expense, tooling costs, and the like, this logic may be implemented by constructing an application-specific integrated circuit (“ASIC”) having thousands of tiny integrated transistors. Such an ASIC may be implemented with CMOS, TTL, VLSI, or another suitable construction. Other alternatives include a digital signal processing chip (“DSP”), discrete circuitry (such as resistors, capacitors, diodes, inductors, and transistors), field programmable gate array (“FPGA”), programmable logic array (“PLA”), and the like.

Storage

Another component of the system 100 is the storage 110. As shown, the storage 110 contains various items of data utilized by the power manager 102c in managing the supply of electrical power to the electrical equipment 108. The storage 110 may be implemented by any form of digital data storage. The storage 110 may be incorporated into the processing facility 102, although it: is shown separately for clarity and distinctness of illustration.

During operation of the system 100, the storage 110 contains various items of information, which for clarity of illustration and without any intended limitation, are illustrated as separate storage components 110a-110g. Nonetheless, The storage components 110a-110g may be implemented by different addresses or extents of contiguous storage, different tracks, logical devices, physical storage devices, or any other hardware and/or memory structure that suits the application.

The storage components 110a-110g are briefly described as follows, with more detailed descriptions of their contents and use appearing below. Start and stop registers 110a-110b are provided to keep track of the times when the primary power source 112 fails (when battery use starts) and when the primary power source 112 resumes (when battery use stops). A cumulative on-battery time register 110c tracks the accumulated time of battery use since the battery's most recent post boot-up full charge. Optionally, as an additional battery monitoring feature, a full charge flag 110d may be used to indicate that the battery 116 has achieved a fully charged state. A battery and equipment profile 110e contains various information about the electrical characteristics of the battery 116 and the electrical equipment 108 to be powered by the battery during primary power source 112 failure. A shutdown timer 110f tracks a designated time to issue a shutdown alert, commence shutdown sequence, or take other appropriate shutdown action as explained below. An “up time” register 110g is used to store the time that the power manager 102c completed boot-up or came “on-line.”.

### OPERATION

Having described the structural features of the present invention, the operational aspect of the present invention will now be described. As mentioned above, the operational aspect of the invention generally involves pre-estimating endurance of a battery to supply electrical power to certain electrical equipment, utilizing software controls to track time of battery use by the equipment, and initiating shutdown of the equipment or issuing an alert when estimated endurance minus battery use equal a predetermined number.

Signal-Bearing Media

In the context of FIG. 1, such operation may be implemented, for example, by operating the power manager 102c, as embodied by one or more of the digital data processing apparatus 200, to execute a sequence of machine-readable instructions. These instructions may reside in various types of signal-bearing media. In this respect, one aspect of the present invention concerns signal-bearing media embodying such a sequence of such machine-readable instructions.

This signal-bearing media may comprise, for example, RAM (not shown) contained within the processing facility 102, as represented by the fast-access storage 206. Alternatively, the instructions may be contained in another signal-bearing media, such as a magnetic data storage diskette 300 (FIG. 3), directly or indirectly accessible by the processor 202. Whether contained in the storage 206, diskette 300, or elsewhere, the instructions may be stored on a variety of machine-readable data storage media. Some examples include as direct access storage (e.g., a conventional “hard drive”, redundant array of inexpensive disks (“RAID”), or another direct access storage device (“DASD”)), serial-access storage such as magnetic or optical tape, electronic read-only memory (e.g., ROM, EPROM, or EEPROM), optical storage (e.g., CD-ROM, WORM, DVD, digital optical tape), paper “punch” cards, or other suitable signal-bearing media, possibly including analog or digital transmission media and analog and communication links and wireless. In an illustrative embodiment of the invention, the machine-readable instructions may comprise software object code, loaded into an AIX kernel extension (device driver) compiled from a language including but not limited to “C,” etc.

Logic Circuitry

In contrast to the signal-bearing medium discussed above, the method aspect of the invention may be implemented using logic circuitry, without using a processor to execute instructions. In this embodiment, the logic circuitry is implemented in the processing facility 102, and is configured to perform operations to implement the method of the invention. The logic circuitry may be implemented using many different types of circuitry, as discussed above.

Overall Sequence of Operation

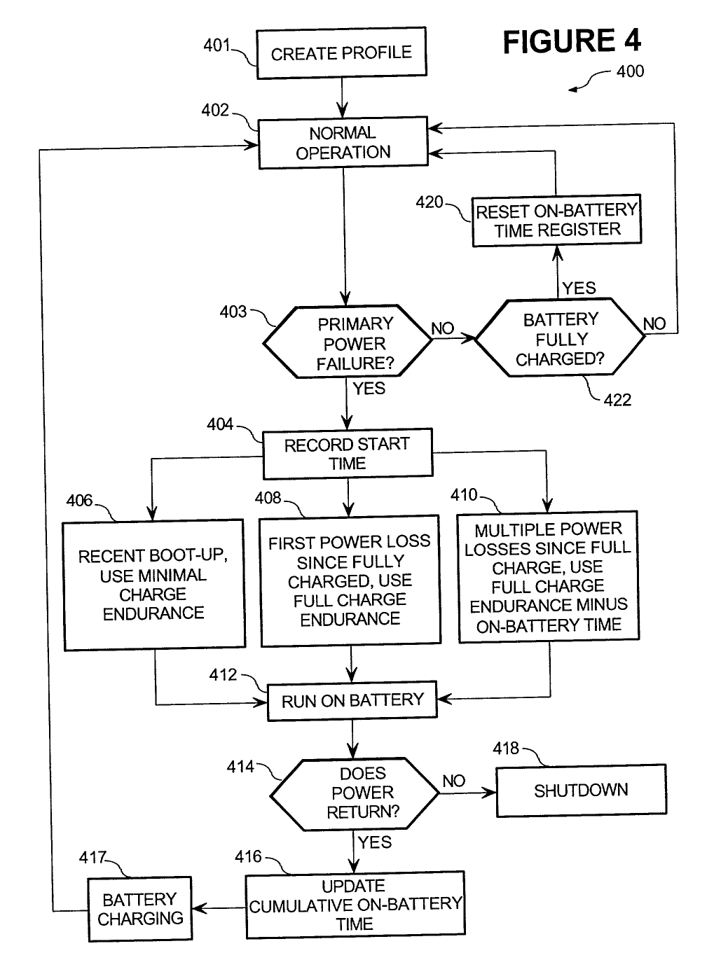

FIG. 4 shows a sequence 400 to illustrate one example of the method aspect of the present invention. Broadly, this sequence provides intelligent battery management services by considering predefined battery and equipment profiles along with real-time battery use to estimate remaining battery endurance; the sequence also takes appropriate action such as issuing an alert or commencing shutdown as battery endurance nears its end. For ease of explanation, but without any intended limitation, the example of FIG. 4 is described in the context of the system 100 specifically described above. As shown below, some of the steps 400 are performed manually, whereas others are performed automatically by components of the system 100.

Step 401 creates a profile specifying electrical output capabilities of the battery 116 and power requirements of the electrical equipment 108. As illustrated, this profile is stored in 110e. For the present example, the processing facility 102 is also included in calculating the power requirements of the electrical equipment 108 since the processing facility 102 draws power from the battery 116 in the event of primary power source failure. At minimum, the profile of step 401 includes the amount of time that the battery 116, fully charged, can adequately supply power to operate the electrical equipment 108 without any contribution from the primary power source 112. This figure may be referred to as the battery's estimated full charge endurance. For purposes of the present example, this value is taken to be five minutes. This computation may consider, for example, the electrical equipment's average power draw, peak power draw, or another expression of power use. The basis for preparing the profile of step 401 may include taking advance measurements of the relevant operating characteristics, referring to manufacturer's publications, or a combination thereof.

Step 401 may be performed by various personnel. In one embodiment, where the a power manager 102c is implemented by a digital data processor, the programmers that prepare the operating code for the power manager 102c also prepare the battery and equipment profile 110e. In another embodiment, the profile 110e is setup by technicians that install the power manager 102c and/or processing facility 102.

Optionally, the profile 110e may also include other specifications in addition to the amount of time that the battery 116, fully charged, can adequately supply power to operate the electrical equipment 108. In the sequence 400 as illustrated, the battery and equipment profile 110e additionally specifies the amount of time that the battery 116, minimally charged, can adequately supply power to operate the equipment 108. This time is the battery's estimated minimal charge endurance. The “minimal charge” is the charge that a completely discharged battery would receive during boot-up of the power manager 102c. For purposes of the present example, the estimated minimal charge endurance is taken to be fifty seconds.

Optionally, an additional component of the profile 110e may include the time that the battery 116 requires to achieve a full charge. This value is referred to herein as “full charge time” and may be available, for example, from product specifications of the battery manufacturer. As explained below, by knowing the battery's time to reach full charge, the power manager 102c can deduce when the battery is fully charged without requiring any voltage sensors or other specialized hardware.

After step 401, the power manager 102c is initiated, boots up, and begins normal operation (step 402). During boot-up, the power manager 102c configures the storage 110 as follows: the start and stop registers 110a-110b are cleared (i.e., zeroed); the cumulative on-battery time register 110c is cleared; and the up time register 110g is filled with the current time according to the clock 102d.

If the primary power source 112 fails (step 403), the activation module 115 begins to supply battery power in substitution for the failed primary power source 112. Aside from the UPS feature of the battery 116, power failure (step 403) triggers the features of the present invention relating to tracking battery use and estimating remaining battery endurance.

More particularly, the sensor 114 detects power loss of step 403. In the illustrated example, the sensor 114 detects whether the electrical equipment 108 is drawing off the battery 116 rather than receiving normal power from the source 112. Alternatively, “failure” of the primary power source may be defined as occurring when the source 112 provides power of inadequate voltage, irregular character, poor quality, or any other prescribed characteristic(s) depending upon the particular implementation of the sensor 114. Responsive to detecting power loss (step 403), the sensor 114 in turn notifies the power manager 102c, resulting in step 404. In step 404, the power manager 102c updates the start register 110a to record the time of invoking battery power. Then, the power manager 102c proceeds to one of steps 406, 408, 410.

The power manager 102c performs step 406 if the power failure (step 403) occurred before the battery has had an opportunity to achieve a full charge after initial boot-up of the power manager 102c. This inquiry may be conducted in various ways. For instance, step 406 may be triggered if the power manager 102c finds that the difference between the current time and the up time register 110g is less than a prescribed amount, clearly less than the predefined “full charge time” stored in the profile 110e. Alternatively, step 406 may be invoked if the full charge flag 110d is not set.

In any case, step 406 serves to compute the battery's safe remaining charge time and set the shutdown timer 110f appropriately. In this situation, the battery voltage is unknown since it has never reached a full charge. Therefore, as a precaution the battery voltage is assumed to be minimal charge, as mentioned above in conjunction with step 401. Relatedly, the battery's endurance is assumed to be its endurance under minimal charge circumstances. Accordingly, the power manager 102c consults the profile 110e to retrieve the estimated minimal charge endurance, which is fifty seconds in this example, and sets the shutdown timer 110f to fifty seconds. If the shutdown sequence of the equipment 108 takes any measurable amount of time, the value of the shutdown timer 110f may be immediately reduced by this amount to guarantee power supply during the entire shutdown sequence. Alternatively, the estimated minimal charge endurance reflected by the profile 110e may be pre-reduced by the estimated shutdown time of the equipment 108.

In contrast to step 406, one of steps 408, 410 is performed if the power failure (step 403) occurred after the battery has reached full charge since initial boot-up of the power manager 102c. Step 408 is performed if the power loss (step 403) is the first since the battery's most recent full charge. In the illustrated system 100, step 408 may be triggered if the power manager 102c finds the following conditions: (1) the full charge flag 110d is “on”, meaning that the battery has reached a full charge, and (2) the start register 110a is empty (or the cumulative on-battery time is zero), meaning that this is the first primary power source failure since achieving that full charge.

Basically, step 408 serves to compute the battery's safe remaining charge time (differently than step 406) and set the timer 110f appropriately. Under the present circumstances, namely the first power failure after the battery has reached a full charge state, the battery voltage is assumed to be a full charge, with the battery's remaining endurance assumed to be its estimated full charge endurance. Accordingly, the power manager 102c consults the profile 110e to retrieve the estimated full charge endurance, which is five minutes in this example, and sets the shutdown timer 110f to five minutes. If the shutdown sequence of the equipment 108 takes any measurable amount of time, the value of the shutdown timer 110f may be reduced by this amount to guarantee power supply during the entire shutdown sequence. Alternatively, the estimated full charge endurance may be pre-reduced by the estimated shutdown sequence time. The power manager 102c also copies the current time as indicated by the clock 102d into the start register 110a to begin recording the on-battery time.

In contrast to steps 406, 408, step 410 is performed if the battery 116 has achieved full charge since boot-up, but the current power loss (step 403) is not the first since achieving the last full charge. In the illustrated system 100, step 410 may be triggered if the power manager 102c finds the following conditions: (1) the full charge flag 110d is “on”, meaning that the battery has reached a full charge since boot-up, and (2) the start register 110a is non-empty (or the cumulative on-battery time is non-zero), meaning that this is not the first primary power source failure since boot-up. In this case, step 410 continues, serving to compute the battery's safe remaining charge time (differently than steps 406 or 408) and set the timer 110f appropriately. Under these circumstances, the battery voltage cannot be assumed to be full charge. Rather, the battery's remaining endurance is calculated as follows: the estimated full charge endurance (from the profile 110e) is reduced by the cumulative on-battery time 110c. As explained below, the cumulative on-battery time tracks the amount of time that the electrical equipment 108 has operated on battery power since the battery's most recent full charge. Accordingly, the power manager 102c sets the shutdown timer 110f to the calculated remaining endurance. If the shutdown sequence of the equipment 108 takes any measurable amount of time, the value of the shutdown timer 110f may be reduced by this amount to guarantee power supply during the entire shutdown sequence (or the estimated full charge endurance may be reduced by this amount).

After step 406, 408, or 410, the electrical equipment 108 runs on power from the battery 116 (step 412). In step 414, the power manager 102c consults the sensor 114 to determine whether the primary power source 112 has been restored. If primary power does not return before expiration of the timer 110f, the power manager 102c commences shutdown of the equipment 108 (step 418). Alternatively, or in addition, the power manager 102c may issue a shutdown alert to prompt an operator to shutdown the electrical equipment 108. The nature and extent of actions taken in step 418 are determined by the programming of the power manager 102c, configured in advance according to the requirements of the application and desires of the user. As an additional feature, if the sensor 114 is equipped with circuitry to detect and report a critically low battery voltage condition (such as the RPC product mentioned above), step 418 may be additionally invoked (early if necessary) in response to such a condition.

In contrast to the foregoing, step 416 (instead of step 418) is performed if primary power returns before expiration of the timer 110f. In this case, the power manager 102c updates the cumulative on-battery time to reflect the battery usage of step 412. More particularly, the power manager 102c updates the stop register 110b with the time of power restoration, and then calculates difference between the start and stop registers 110a-110b, adds this value to the contents of the cumulative on-battery time register 110c, and then replaces contents of the register 110c with this calculated sum.

After step 416, the battery 116 in step 417 continues the process of receiving charge, as was automatically begun in step 414 when the power source 112 was restored. After step 417, the power manager returns to normal operations in step 402, as described above. Also mentioned above, step 403 repeatedly checks for failure of the primary power source 112. In the absence of power loss, the power manager 102c considers whether the battery has achieved full charge (step 422). In the illustrated system 100, which is primarily software based, the battery 116 is designated as having a full charge when it receives uninterrupted power for the “full charge time” specified in the profile 110e. In one example, this designation is made as follows. In one case, the power manager 102c assumes that the battery 116 has a full charge if the power manager 102c has been conducting normal operations (step 402) for a time period equal to the full charge time minus the processing facility's boot-up time (since the battery 116 charges during boot-up in the present example). In another case, although not necessary to the invention, a hardware device such as voltage sensor may be used to sense full charge voltage of the battery 116.

In any case, the power manager 102c returns to step 402 directly from step 422 if the battery has not achieved full charge. If step 422 finds that the battery has achieved full charge, the power manager 102c responds by clearing the cumulative on-battery time 110c, clearing the start register 110a, and setting the full charge flag 110d (step 420) before returning to step 402.

### Redundant Features

Optionally, the hardware 100 and operating sequence 100 may be modified to operate redundant power managers 102c and redundant storage 110 including the components 110a-110g. In this embodiment, a primary power manager carries out the functions of power manager 102c as discussed above, and a secondary power manager stands ready to assume responsibility should the primary power manager fail. Whenever the primary power manager updates any of the storage components 110a-110g, it also sends a message to the secondary power manager summarizing the updates made. The secondary power manager then updates its storage components to mirror the storage 110. If the primary power manager fails, the secondary power manager can immediately begin operation using its mirrored storage.

### OTHER EMBODIMENTS

While the foregoing disclosure shows a number of illustrative embodiments of the invention, it will be apparent to those skilled in the art that various changes and modifications can be made herein without departing from the scope of the invention as defined by the appended claims. Furthermore, although elements of the invention may be described or claimed in the singular, the plural is contemplated unless limitation to the singular is explicitly stated. Additionally, ordinarily skilled artisans will recognize that operational sequences must be set forth in some specific order for the purpose of explanation and claiming, but the present invention contemplates various changes beyond such specific order.

What is claimed is:

1. A power management method for use in a system including electrically powered equipment utilizing a primary power source where a battery provides backup power during failure of the primary power source, the method comprising operations of:
monitoring charge state of the battery including whether the battery is substantially fully charged;
monitoring cumulative on-battery time of the equipment since a most-recent substantially full charge of the battery;
monitoring condition of the primary power source including whether the primary power source has failed, and
responsive to each failure of the primary power source, applying a predetermined formula to compute a remaining battery endurance, and starting a timer to track expiration of the remaining battery endurance;
responsive to each restoration of the primary power source, stopping the timer;
responsive to the timer reaching a predetermined level, commencing one or more predetermined shutdown actions.

2. The method of claim 1, the computation of the remaining battery endurance including a safety margin.

3. The method of claim 1, the shutdown actions comprising:
commencing shutdown of the electrically powered equipment.

4. The method of claim 1,
the operation of monitoring charge state of the battery comprising estimating that the battery is substantially fully charged responsive to the battery receiving charge for a prescribed period of time.

5. The method of claim 1, where:
the operation of applying the predetermined formula comprises determining whether the battery has previously reached full charge, and if not establishing the remaining battery endurance as an estimated partial charge battery endurance, otherwise establishing the remaining battery endurance as an estimated full charge battery endurance minus any cumulative on-battery time.

6. The method of claim 1, where the operation of applying the predetermined formula comprises:
determining whether the battery has previously reached full charge, and if so, establishing the remaining battery endurance as an estimated full-charge battery endurance minus an estimated shut down period minus any cumulative on-battery time.

7. The method of claim 1, where the operation of applying the predetermined formula comprises:
determining whether the battery has previously reached full charge, and if not establishing the remaining battery endurance as an estimated partial-charge battery endurance minus an estimated shut down period.

8. The method of claim 7, where the operations are performed by a power manager and further comprise:
estimating the partial-charge battery endurance by performing operations comprising estimating battery endurance starting at a level of battery power that would be achieved by charging the battery for an amount of time required for the power manager to boot up.

9. A method of managing backup battery power in a system where a battery supplies power to electrical equipment when a primary power source fails, comprising operations of:
receiving one or more estimates of endurance of the battery to supply electrical power to the equipment;
tracking battery use by the electrical equipment;
utilizing software to determine when estimated endurance minus battery use equal a predetermined difference, and responsive thereto commencing one or more predetermined shutdown actions.

10. A method of managing backup battery power, comprising the operations of calculating a cumulative amount of time that prescribed equipment has been running on battery power since full charge of the battery, and utilizing the calculation to provide a output indicating an amount of time that the equipment can continue to operate on battery power before exhausting a predetermined battery endurance.

11. A signal-bearing medium tangibly embodying a program of machine-readable instructions executable by a digital processing apparatus to perform a power management method for use in a system including electrically powered equipment utilizing a primary power source where a battery provides backup power during failure of the primary power source, the method comprising operations of:
monitoring charge state of the battery including whether the battery is substantially fully charged;
monitoring cumulative on-battery time of the equipment since a most-recent substantially full charge of the battery;
monitoring condition of the primary power source including whether the primary power source has failed, and
responsive to each failure of the primary power source, applying a predetermined formula to compute a battery endurance, and starting a timer to track expiration of the remaining battery endurance,
responsive to each restoration of the primary power source, stopping the timer;
responsive to the timer reaching a predetermined level, commencing one or more predetermined shutdown actions.

12. The medium of claim 11, the shutdown actions comprising:
commencing shutdown of the electrically powered equipment.

13. The medium of claim 11, the operations further comprising:
the operation of monitoring charge state of the battery comprising estimating that the battery is substantially fully charged responsive to the battery receiving charge for a prescribed period of time.

14. The medium of claim 11, where:
the operation of applying the predetermined formula comprises determining whether the battery has previously reached full charge, and if not establishing the battery endurance remaining as an estimated partial charge battery endurance, otherwise establishing the remaining battery endurance as an estimated full charge battery endurance minus any cumulative on-battery time.

15. The medium of claim 11, where the operation of applying the predetermined formula comprises:
determining whether the battery has previously reached full charge, and if so, establishing the remaining battery endurance an estimated full-charge battery endurance minus an estimated shut down period minus any cumulative on-battery time.

16. The medium of claim 11, where the operation of applying the predetermined formula comprises:
determining whether the battery has previously reached full charge, and if not establishing the remaining battery endurance as an estimated partial-charge battery endurance minus an estimated shut down period.

17. The medium of claim 16, where the operations are performed by a power manager and further comprise:
estimating the partial-charge battery endurance by performing operations comprising estimating a battery endurance starting at a level of battery power that would be achieved by charging the battery for an amount of time required for the power manager to boot up.

18. A signal-bearing medium tangibly embodying a program of machine-readable instructions executable by a digital processing apparatus to perform a process of managing backup battery power in a system where a battery supplies power to electrical equipment when a primary power source fails, the process comprising operations of:
receiving one or more estimates of endurance of the battery to supply electrical power to the equipment;
tracking battery use by the equipment;
determining when estimated endurance minus battery use equal a predetermined difference, and responsive thereto commencing one or more predetermined shutdown actions.

19. A logic circuit of multiple interconnected electrically conductive elements configured to perform a process of managing backup battery power in a system where a battery supplies power to electrical equipment when a primary power source fails, the process comprising operations of:
receiving one or more estimates of endurance of the battery to supply electrical power to the equipment;
tracking battery use by the equipment;
determining when estimated endurance minus battery use equal a predetermined difference, and responsive thereto commencing one or more predetermined shutdown actions.

20. A power management system, comprising:
battery power source providing backup power to electrically powered equipment during failure of a primary power source;
a sensor of primary power source failure;
a timer;
a power manager programmed to perform operations comprising:
monitoring charge state of the battery including whether the battery is substantially fully charged;
monitoring cumulative on-battery time of the equipment since a most-recent substantially full charge of the battery;
monitoring condition of the primary power source including whether the primary power source has failed, and
responsive to each indication by the sensor of failure of the primary power source, applying a predetermined formula to compute remaining battery endurance, and starting the timer to track expiration of the remaining battery endurance;
responsive to each restoration of the primary power source, stopping the timer;
responsive to the timer reaching a predetermined level, commencing one or more predetermined shutdown actions.

21. The system of claim 20, further comprising the electrically powered equipment.

22. A backup power system, comprising:
a battery;
a sensor of battery use;
a power manager coupled to the battery and the sensor and programmed to perform operations comprising:
receiving one or more estimates of endurance of the battery to supply electrical power to prescribed electrical equipment;
tracking battery use by the equipment;
determining when estimated endurance minus battery use equal a predetermined difference and responsive thereto commencing one or more predetermined shutdown actions.

23. A backup power system, comprising:
a battery;
sensor means for detecting battery use;
processing means coupled to the battery and the sensor means for receiving one or more estimates of endurance of the battery to supply electrical power to the prescribed electrical equipment, tracking battery use by the equipment, and determining when estimated endurance minus battery use equal a predetermined difference, and responsive thereto commencing one or more predetermined shutdown actions.
